(19) United States
(12) Patent Application Publication
(10) Pub. No.: US 2005/0242457 A1
(43) Pub. Date: Nov. 3, 2005

(54) Composite decking

(76) Inventor: Kevin A. Seiling, Monaca, PA (US)

Correspondence Address: COHEN & GRIGSBY, P.C., 11 STANWIX STREET, 15TH FLOOR, PITTSBURGH, PA, 15222, US

(21) Appl. No.: 11/178,840

(22) Filed: Jul. 11, 2005

Related U.S. Application Data
(62) Division of application No. 10/800,501, filed on Mar. 15, 2004.
Application No. 10/800,501 is a continuation-in-part of application No. 10/001,730, filed on Nov. 2, 2001.

(51) Int. Cl. B29C 44/20

(52) U.S. Cl. 264/45.9; 264/148; 264/284; 264/51; 264/54

(57) ABSTRACT

A composite plank (146) having a curved bottom surface (154) made by the method wherein a feed mixture of thermoplastic polymer material and glass fibers are provided to an extruder (10). The extruder compresses the feed mixture to form a thermoplastic/glass melt in the presence of a blowing agent. The melt is extruded through a die (26) to form a strand or extruded length (110) that is further shaped and cooled in an array of calibrators (112). A cutter (142) severs sections of the extruded length (110) to form planks (146).

### CROSS REFERENCE

This application is a divisional of U.S. patent application Ser. No. 10/800,501 (Attorney Docket Number 01-180 CIP) filed on Mar. 15, 2004, which is a continuation-in-part of copending U.S. patent application Ser. No. 10/001,730 (Attorney Docket Number 01-180) filed on Nov. 2, 2001.

### BACKGROUND OF THE INVENTION

1. Field of the Invention

The presently disclosed invention relates to compositions and methods for making composite construction materials and, more particularly, to decking made from such compositions and according to such methods.

2. Description of the Prior Art

For many years wood has been the material of choice for certain structural applications such as decks and porches. However, wood has a major disadvantage in that it is subject to attack from mold, mildew, fungus and insects. Protection from these causes is usually afforded by protective coatings or by treatment with chemicals or metals such as arsenic. However, these protective methods have the disadvantage of requiring periodic maintenance or employing the use of human toxins.

In addition, wood is also subject to color changes as a result of exposure to sunlight or natural elements. In some applications, such as outdoor decks, such reactivity manifests in various ways such as color spots under furniture or mats as well as other undesirable respects.

To avoid these difficulties, in some cases metal materials have been used in prior art construction, as an alternative to wood. Metal materials are impervious to fungus and insect hazards, but they are subject to corrosion processes. In addition, the weight and/or cost of metal materials makes them unsuitable for a number of applications.

To overcome these difficulties, various substitutes for wood decking planks and similar structural members have been developed in the prior art. As an example, U.S. Pat. No. 5,660,016 to Erwin discloses decking plank that is composed of an extruded polyvinyl chloride outer shell that is filled with a rigid polyurethane foam core. As another example, U.S. Pat. No. 6,128,880 to Meenan describes a modular decking system wherein various system components are designed for interlocking or cooperative assembly. However, such specialty systems have often required special features such as attachment systems for securing the planks. Other improvements in composite decking have been directed to ornamental features, such as shown in U.S. Design Patent Des. 418,926.

In some processes for making composite members, a vinyl polymer is used in combination with wood elements. For example, U.S. Pat. Nos. 2,926,729 and 3,432,885 describe thermoplastic polyvinyl chloride cladding that is combined with wood members to form architectural components. According to other technology, a thermoplastic resin layer can be bonded to a thermoset resin layer. For example, in U.S. Pat. No. 5,074,770, a vacuum formed preform is treated to modify the polymeric structure of the resin surface and improve adhesion with a thermoplastic resin layer. Processes such as described in U.S. Pat. No. 5,098,496 to Breitigam for making articles from heat curable thermosetting polymer compositions are also known in the prior art.

In other cases, vinyl polymeric materials have been comprised of a vinyl polymer in combination with one or more additives. Both rigid and flexible thermoplastic materials have been formed into structural materials by extrusion and injection molding processes. In some cases, these materials have also included fiber, inorganic materials, dye and other additives. Examples of thermoplastic polyvinyl chloride and wood fiber blended to make a composite material are found in U.S. Pat. Nos. 5,486,553; 5,539,027; 5,406,768; 5,497,594; 5,441,801; and 5,518,677.

In some instances, foamed material has also been used to make structural members. Foamed thermoplastics are typically made by dispersing or expanding a gaseous phase throughout a liquid polymer phase to create a foam comprising a polymer component and an included gas component in a closed or open structure. The gaseous phase is produced by blowing agents. Such blowing agents can be chemical blowing agents or physical blowing agents. For example, U.S. Pat. No. 5,001,005 to Blaupied discloses foamed core laminated panels wherein a foamed core, such as a thermosetting plastic foam, is provided with flat rigid sheets or webbed flexible facer sheets. The facer sheets are formed of various materials such as glass fibers bonded with resin binders. Other facer materials include paper, plastic, aluminum foil, metal, rubber and wood.

In some cases, processes have been applied in particular to the manufacture of structural components from foamed thermoplastic polymer and wood fibers. One example is shown in U.S. Pat. No. 6,054,207. Other improvements to foam-filled extruded plastic decking plank have been directed to functional features such as the non-slip surface coating of grit material on acrylic paint that is described in U.S. Pat. No. 5,713,165 to Erwin.

However, in the prior art it has not been known to use a foamed polymer material, particularly polyvinyl chloride, in combination with a glass fiber. As further described in connection with the presently preferred embodiment, it has been found that this combination of foamed polymer and glass fiber affords a material with properties that are especially suited for use as a wood substitute in structural applications. Among other advantages, the material has been found to be highly weatherable in that it resists fading or color change due to exposure to sunlight or environmental element. In addition, the material has been found to have a low coefficient of thermal expansion, a high modulus (bending strength), and high resistance to cracking.

Whether decking is made of wood or composite materials, a persistent problem in the prior art has been that the decking tends not to seat firmly on the support joist or other support surface to which the decking is secured. It is well known that as natural wood cures or ages, it has a tendency to warp or shrink so that it's form is somewhat varied. While various composite materials were proposed to avoid the problems and shortcomings of natural wood, the composites also were subject to some degree of warping or shrinkage during the post-manufacturing “curing” stage. In either the case or wood or composite products, they have been somewhat prone to warping and shrinkage. Therefore, the decking made from either type of material was somewhat prone to rocking or shifting under foot.

Even when the composite or wood decking was substantially true and straight, it sometimes did not fit tightly to the support surface because the joist or other supports had warped or shifted out of true alignment. Again, the result has been rocking or shifting of the deck planks. Accordingly, there was a need in the prior art for decking that will reduce that tendency.

As described in connection with the presently preferred embodiment, it has been found that the disclosed composite decking can be formed so as to accommodate irregularities in the support joist and/or the composite decking itself so as to form a more secure base with the joist. In this way, the rocking tendency of decking planks can be greatly reduced.

### SUMMARY OF THE INVENTION

In accordance with the subject invention, a deck plank made of a composite polymer material includes a top surface, first and second side surfaces that are orthogonal to the top surface, and a bottom surface that defies a generally concave surface between the first and second side surfaces. Preferably, the concave surface of the bottom surface defines a generally continuous arc. More preferably, the arc has a first end that joins with the first side surface and a second end that joins with the second side surface and the arc has a substantially constant radius between the first and second ends.

Also in accordance with the subject invention, a method for making deck planks includes the steps of blending polyvinyl chloride with glass fibers to make a polyvinyl chloride-glass melt. The melt is exposed to a blowing agent to form voids in the melt and the melt is then extruded through a die that has top and bottom surfaces and first and second side surfaces. The extruded material is pulled through a plurality of calibrators where it is cooled and shaped. Each of the calibrators has a respective opening that is defined by top and bottom walls and also by first and second side walls. Preferably, one of the top or bottom surfaces of at least one calibrator opening defines a generally continuous, convex surface. More preferably, the convex surface of the calibrator opening defines an arc having a substantially continuous convex surface.

Also in accordance with the subject invention, a composite deck plank is made according to the steps of blending polyvinyl chloride with glass fibers that have a screen size in the range of 1/64 inch to 1/4 inch to make a polyvinyl chloride-glass melt. The melt is exposed to a blowing agent to form voids in the melt and the melt is then extruded through a die that has top and bottom surfaces and first and second side surfaces. The extruded material is pulled through a plurality of calibrators where it is cooled and shaped. Each of the calibrators has a respective opening that is defined by top and bottom walls and also by first and second side walls. At least one of the top or bottom surfaces of at least one calibrator opening defines a generally continuous, convex surface. Preferably, the glass fibers have a diameter in the range of 5 microns to 30 micons and a length in the range of 50 microns to 900 microns.

Still further in accordance with the subject invention, a process for making deck planks includes the steps of method for making a structural shape includes the steps of combining a thermoplastic polymer material with glass fibers as ingredients to form a homogeneous feed material. The thermoplastic polymer material in the feed material is then liquefied and blended with the glass fibers to form a thermoplastic/glass melt wherein the concentration of glass fibers is in the range of 1% to 18% by weight. The thermoplastic/glass melt is exposed to a blowing agent that cooperates with the thermoplastic/glass melt to form closed cells in the melt. The thermoplastic/glass melt is then extruded through a die The extruded material is pulled through a plurality of calibrators where it is cooled and shaped. Each of the calibrators has a respective opening that is defined by top and bottom walls and also by first and second side walls. One of the top or bottom surfaces of at least one calibrator opening defines a generally continuous, convex surface. Preferably, the blowing agent is selected from the group consisting of azodicarbonamide, carbon dioxide, nitrogen, chloroflorocarbons, and butane.

Other features, advantages, and objects of the presently disclosed invention will become apparent to those skilled in the art as a description of a presently preferred embodiment thereof proceeds.

### BRIEF DESCRIPTION OF THE DRAWINGS

Presently preferred embodiments of the disclosed invention are shown and described in connection with the accompanying Figures wherein:

FIG. 1 is a schematic diagram that illustrates a preferred embodiment of the process for making the disclosed deck planks;

FIG. 2 is a cross-section of the extruder illustrated in FIG. 1 at the location indicated by lines 2-2 in FIG. 1;

FIG. 3 is a schematic diagram that illustrates another preferred embodiment of the process for making the disclosed deck planks; and

FIG. 4 is a diagram of gas injection apparatus that is used in combination with the extruder that is illustrated in FIG. 3.

FIG. 5 is a cross-section of a die taken along the lines 5-5 of FIG. 1 and FIG. 3.

FIG. 6 is a cross-section of a calibrator taken along the lines 6-6 in FIG. 1 and FIG. 3.

FIG. 7 is a cross-section of the deck plank disclosed herein taken along the lines 7-7 of FIG. 1 and FIG. 3.

### DESCRIPTION OF A PRESENTLY PREFERRED EMBODIMENT OF THE INVENTION

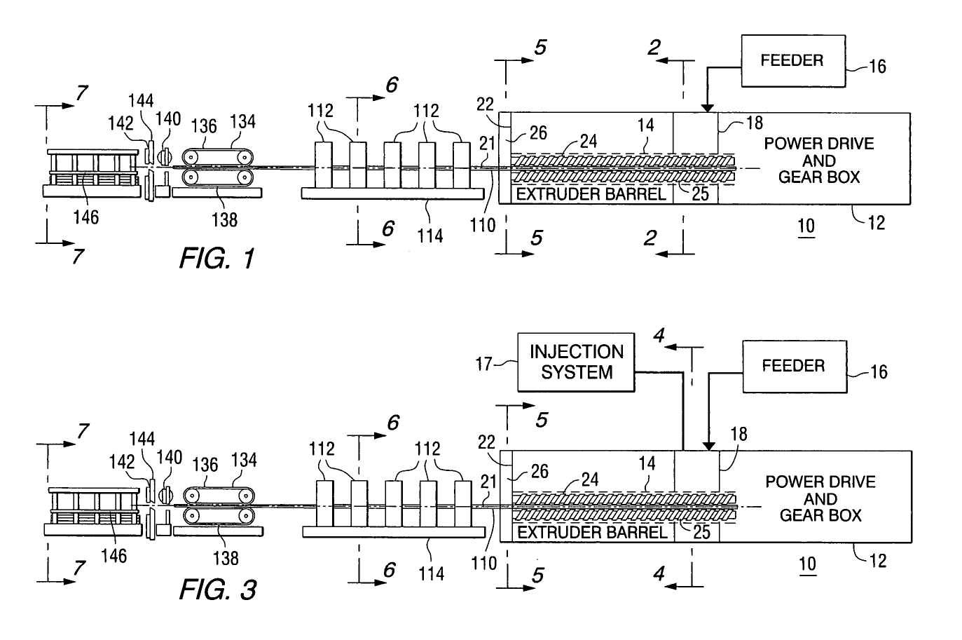

As shown in FIG. 1, an extruder 10 includes a power drive and gear box 12 that is mechanically coupled to an extruder barrel 14. Extruder 10 further includes a feeder 16. Preferably, extruder 10 is a conical twin screw extruder of the type such as is available from Milacron, Inc. or equivalent. However, commercially available single screw or parallel twin screws extruders can also be used in the practice of the disclosed invention.

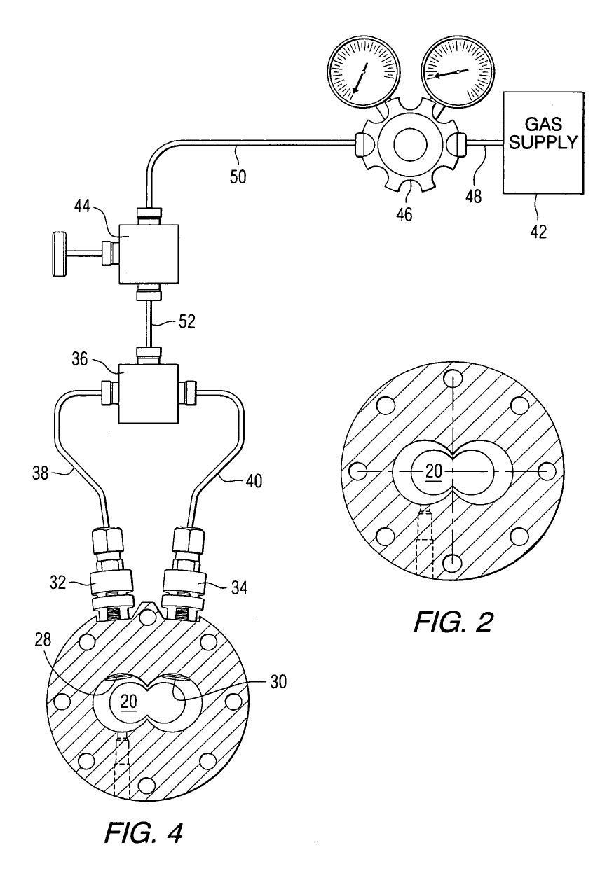

As well known to those skilled in the relevant art, in such commercially available extruders the feed material flows from the feeder 16 to the input end 18 of the barrel 14. According to the preferred embodiment of FIGS. 1 and 2, barrel 14 defines an internal tapered chamber 20 that is aligned along a longitudinal axis 21 that extends between the input end 18 and the output end 22 of barrel 14. In the preferred embodiment of FIGS. 1 and 2, extruder 10 is a conical twin screw extruder so that the cross-sectional area of chamber 20 decreases along longitudinal axis 21 at longitudinal positions along axis 21 moving in the direction away from the input end 18 and toward the output end 22. Extruder 10 further includes screws 24 and 25 (FIG. 1 only) that are located in the tapered chamber 20 and are mechanically coupled to the gear box 12.

As is also well known to those skilled in the relevant art, when the gear box is powered, it causes extruder screws 24 and 25 to rotate in chamber 20 as feed material is supplied from feeder 16 to the input end 18 of barrel 14. The rotation of extruder screws 24 and 25 carries the feed material through chamber 20 in the direction toward the output end 22 of barrel 14. A die 26 is connected to the barrel 14 at output end 22.

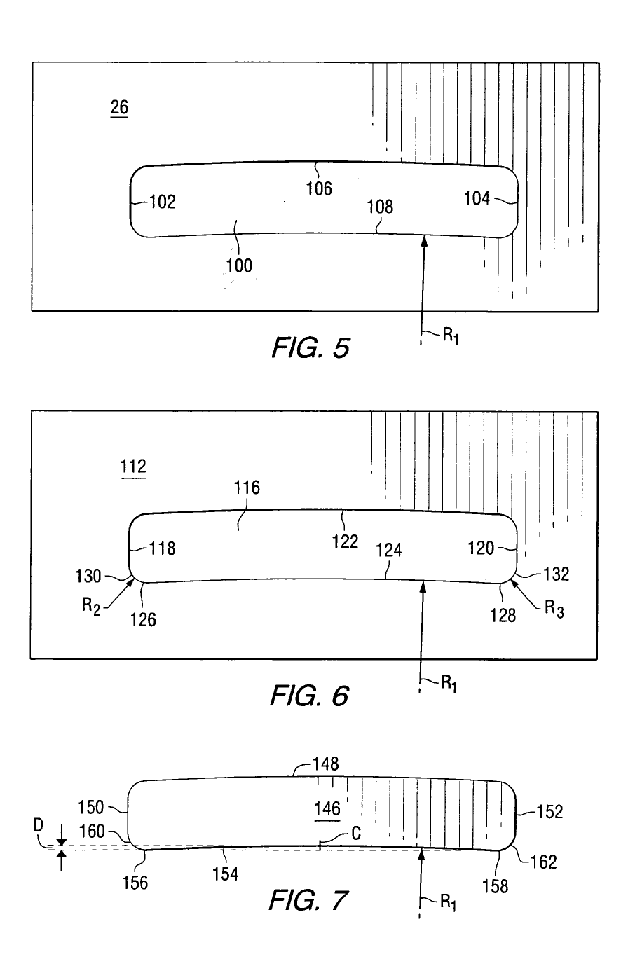

Die 26 has a die port with a perimeter profile that is more particularly described in connection with FIG. 5. As shown in FIG. 5, die 26 has an opening or die port 100 that is defined by a first side surface 102 and a second side surface 104. First side surface 102 is oppositely disposed on die port 100 from the second side surface 104. Die port 100 is further defined by a top surface 106 and a bottom surface 108. Top surface 106 is oppositely disposed on die port 100 from bottom surface 108. In addition, top surface 106 and bottom surface 108 are substantially orthogonal with respect to first and second side surfaces 102 and 104.

Referring again to FIG. 1, as the feed material passes from the input end 18 to the output end 22 of barrel 14, the cross-sectional area of the chamber 20 decreases and the feed material is compressed. The compression and frictional forces on the feed material cause the pressure and the temperature of the feed material to increase. At some point in chamber 20 of the barrel 14 between input end 18 and output end 22, the temperature is elevated to the point that feed material forms a fluid melt. At end 22 of barrel 14, the fluid melt is forced through the port 100 of the die 26 to produce a length of extruded material 110.

When viewed in the direction normal to the longitudinal axis 21, at longitudinal positions of axis 21 that are adjacent to die 26, the extruded length 110 of material has a cross-sectional profile that substantially corresponds to the profile of the die port 100 in die 26. As extruded length 110 moves to longitudinal positions of axis 21 that are further away from die 26, the extruded length 110 is cooled while the cross-sectional shape, or profile, is further shaped by a liner array of calibrators 112 that are arranged on a calibrator table 114. Calibrators 112 are located at longitudinal positions of axis 21 that are spaced apart to allow the extruded length to be cooled by contact water baths or sprays that are located between calibrators 112.

As further shown in connection with FIG. 6, each of the calibrators 112 has a respective port 116 and the extruded length 110 travels through each of the respective ports 116. Each of the calibrator ports 116 are defined by a first side surface 118 and a second side surface 120. First side surface 118 is oppositely disposed on calibrator port 116 from the second side surface 120. Calibrator port 116 is further defined by a top surface 122 and a bottom surface 124. Top surface 122 is oppositely disposed on calibrator port 116 from bottom surface 124. In addition, top surface 122 and bottom surface 124 are substantially orthogonal with respect to first and second side surfaces 118 and 120.

In accordance with the presently disclosed invention, at least one of calibrators 112 has a calibrator port 116 with a bottom surface 124 that defines a generally continuous convex surface that defines an arc of substantially constant radius R₁. As shown in the embodiment of FIG. 6, it has been found that an arc having a radius R₁ of substantially 49 inches provides an extrusion 110 with a preferred shape as hereinafter is more fully described.

FIG. 6 also shows that generally continuous convex surface of bottom surface 124 of the calibrator 112 has a first end 126 that joins with the first side surface 118 of calibrator 112 and a second end 128 that joins with the second side surface 120 of calibrator 112. The junction of the first end 126 and the first side surface 118 defines a first curved shoulder 130 and the junction of the second end 128 and the second side surface 120 defines a second curved shoulder 132. First curved shoulder 130 defines a constant radius surface R₂ and second curved shoulder 132 also defines a constant radius surface R₃. Preferably, the radius of each of said first curved shoulder 130 and the second curved shoulder 132 is not substantially greater than 0.25 in. As further shown in FIG. 1, the extruded length 110 passes through a puller 134 of the type that is known to those skilled in the art. Puller 134 includes two oppositely disposed treads 136 and 138 that impinge on opposite sides of the extruded length 110 as it passes through the puller 134. In this way, puller 134 serves to draw the extruded length through the liner array of calibrators 112.

As the extruded length exits the puller 134, it passes under an embossing wheel 140. The surface of embossing wheel 140 that contacts the extruded length 110 is etched with a pattern such that as the embossing wheel turns on the top surface of the extruded length, the pattern on embossing wheel 140 is impressed into the extruded length. Alternatively, it is sometimes preferred that the extruded length is passed under embossing wheel after the extruded length has been cut into discrete planks by cutter 142. In that case embossing wheel 140 is located on a separate line. The reason why that is preferred is to allow the extruded material to further cool and become harder.

Finally, the extruded length is passed through a cutter 142. Cutter 142 includes a blade 144 that operates in a guillotine fashion to sever the extruded length 110 into discrete planks 146. When a given length of extruded material passes under blade 144, the blade drops down to sever that length of extruded material into a plank 146. To obtain a cut that is generally orthogonal to the extruded length 110, cutter 142 translates blade 144 along a predetermined longitudinal segment of axis 26 at the same rate of travel as extruded length 110. In this way, blade 144 keeps the same position relative to the extruded length 110 while the cutter 142 is severing the plank 146 from extruded length 110.

FIG. 7 shows an end view or profile of the plank 146. Due to the curved bottom surface of the calibrator 112, a curved bottom surface is also established in the extruded length 110 and, therefore, also in plank 146. More specifically, plank 146 includes a top surface 148 and first and second sides surfaces 150 and 152 that are substantially orthogonal to top surface 148. Side surfaces 150 and 152 are also oppositely disposed on the deck plank 146. A bottom surface 154 is located between the first and second side surfaces 150 and 152 and is oppositely disposed from the top surface 148. Bottom surface 154 defines a generally concave surface between the first side surface 150 and the second side surface 152. The concave surface of bottom surface 154 defines a generally continuous arc between the first side surface 150 and the second side surface 152. Bottom surface 154 defines an arc of substantially constant radius R₁. Preferably, the arc of radius R₁ is greater than 50 inches.

Preferably, the continuous arc of bottom surface 154 has a first end 156 that joins with the first side surface 150 and also has a second end 158 that joins with the second side surface 152. The junction of the first end 156 of bottom surface 154 and the first side surface 150 defines a first curved shoulder 160 and the junction of the second end 158 of bottom surface 154 and the second side surface 152 defines a second curved shoulder 162. Preferably, first curved shoulder 160 and second curved shoulder 162 each define a constant radius that is not greater than substantially 0.25 in.

The profile shape of the extruded plank 146 has been found to be advantageous in that, among other reasons, the concave shape of the bottom surface allows the plank to more readily contact the supporting joists at curved shoulders 160 and 162 while the portion of the continuous arc of bottom surface 154 that is located between first and second ends 156 and 158 and also between first and second curved shoulders 160 and 162 is slightly elevated from the joists. Preferably, the elevation between the bottom surface 154 and the supporting joists is approximately 0.063 in. at the center-point C on bottom surface 154 between first and second ends 156 and 158. This has been found to reduce rolling and rocking movement of the plank 146 when it is walked upon.

In accordance with the presently disclosed invention, the feed material includes, as ingredients, a thermoplastic polymer material and glass fibers. As herein disclosed, the thermoplastic polymer material is selected from the group consisting of polyvinyl chloride, polyethylene, and polypropylene. Preferably, the thermoplastic polymer material is polyvinyl chloride beads because polyvinyl chloride has been found to result in a composition that is highly weatherable. The polyvinyl chloride and glass fibers are combined by mixing them together or by blending them together in feeder 16 as the material flows from feeder 16 to the input end 18 of barrel 14. In either case, the polyvinyl chloride and glass fibers form a feed mixture that is fed into barrel 14 at input end 18.

Inside barrel 14, screws 24 and 25 convey the feed mixture through chamber 20 in the general direction along axis 21 away from input end 18 and toward output end 22. As the feed mixture passes through chamber 20, the polyvinyl chloride/glass fiber mixture is compressed. The increasing temperature of the feed mixture in the extruder barrel 14 causes the polyvinyl chloride to melt or liquefy and combine with the glass fibers to form a thermoplastic/glass melt of polyvinyl chloride that is imbedded with glass fibers. The thermoplastic/glass melt or polyvinyl chloride/glass melt is thereafter extruded through the die port 100 of die 26 to form extruded length 110.

It has been found that if the glass fibers that are used in the feed mixture have parameters within selected ranges, the extruded product will have a relatively high modulus, i.e. a greater bending strength. Such composition is particularly useful in certain applications such as outdoor decking wherein the extruded product will be exposed to relatively high shear loading. In accordance with the disclosed invention, the glass fibers have the following parameters: screen size 1/64 in. to ¼ in.; fiber diameter 5μ to 30μ; fiber length 50μ to 900μ; and bulk density of 0.275 grams/cc to 1.05 grams/cc (where μ symbolizes microns).

FIGS. 1 and 2 illustrate a preferred embodiment of the disclosed invention in which a chemical blowing agent is used as a feed mixture ingredient in combination with the thermoplastic polymer material and the glass fiber. The chemical blowing agent is a foaming agent that is mixed with the thermal plastic material and glass fiber as a component of the feed mixture. The chemical blowing agent can be mixed with the polymer material and glass fibers to form a feed mixture, or it can be blended together with the polymer and glass as those materials are fed from feeder 16 to the extruder feed input. To better regulate the proportion of foaming agent that is introduced within more precise limits, the foaming agent is pre-blended with a carrier material so that the foaming agent composes a selected, proportional amount of the blended mixture. Suitable carrier materials for use in such a pre-blended mixture are calcium carbonate, polyvinyl chloride, or ethylene vinyl acetate.

In the embodiment of FIGS. 1 and 2, as the extruder screws 24 and 25 convey the feed material from the input end 18 of chamber 20 to the output end 22, the chemical blowing agent reacts chemically in response to the increase in temperature and pressure in the chamber 20 of the extruder barrel 14. The chemical reaction of the blowing agent produces reactant gases that mix with the thermoplastic/glass melt to form closed internal cells in the thermoplastic/glass melt. In the preferred embodiment, the closed cells define voids in the composition which voids compose in the range of 30% to 70% of the volume that is defined within the surface of the finished composite member. The closed cells formed by the chemical blowing agent reduce the density of the thermoplastic/glass melt and, thereafter, also reduce the density of the extruded shape. Preferably, the specific gravity of the composite material is in the range of 0.5 to 1.0.

Chemical blowing agents such as described herein can be of either an exothermic or endothermic type. The exothermic blowing agent creates heat as it decomposes. A preferred example of an exothermic blowing agent in accordance with the invention herein disclosed is azodicarbonamide. When sufficiently heated, azodicarbonamide decomposes to nitrogen, carbon dioxide, carbon monoxide, and ammonia. The endothermic blowing agent absorbs heat as it decomposes. Examples of a preferred endothermic blowing agent in accordance with the presently disclosed invention are sodium bicarbonate and citric acid. Also, the endothermic and exothermic blowing agents can be used in combination. For example, azodicarbonamide can be combined with citric acid and with sodium bicarbonate.

In the presently disclosed embodiment of FIGS. 3 and 4, components that are similar to those that are described in connection with FIGS. 1 and 2 are identified by corresponding reference characters. In the embodiment of FIGS. 3 and 4, the barrel is further provided with injection ports 28 and 30. Injection ports 28 and 30 are used to introduce a physical blowing agent that is intended to reduce the density of the melt as is more specifically described herein. As shown in FIGS. 3 and 4, the blowing agent is introduced through the extruder barrel and the injector assembly into the melt. In some extruding applications, increased pressure and temperature of the thermoplastic material causes off gases to be produced at the end 22 of extruder barrel 14. Vents are sometimes provided in the extruder barrel for the purpose of establishing a decompression zone for releasing unwanted gasses. However, in the embodiment that is illustrated in FIGS. 3 and 4, there is no decompression zone.

Similarly to the chemical blowing agent, the physical blowing agent causes the melt to incorporate, internal, closed cell structures in the liquid melt. In accordance with the preferred embodiment of FIGS. 3 and 4, the blowing agent is of the type that is a physical blowing agent that is a gas. The physical blowing agent is injected through the injection system that is illustrated in FIG. 4 and through the extruder barrel 14 into the thermoplastic/glass melt. In accordance with the preferred embodiment, the physical blowing agent can be a pressurized gas such as nitrogen, carbon dioxide, fractional butanes, or chlorofluorocarbons. The gas delivery pressure must be greater than the melt pressure. Typical injection pressures are in the range of about 2,000 to 4,000 psi. The physical mixing takes place in the area of internal chamber 20 between the injector ports 28 and 30 and the die 26.

The injector assembly shown in FIG. 4 includes two nozzles 32 and 34 that are connected to a tee 36 by lines 38 and 40. Tee 36 is connected to a pressurized gas supply 42 through a control valve 44, a regulator 46, and lines 48, 50 and 52. In the operation of the injector assembly, a physical blowing agent of pressured gas is injected at pressure that is relatively higher than the pressure in internal chamber 20 at the location of nozzles 32 and 34. Typically, the injection pressure is in the range of 2000 to 6000 psi. The gas blowing agent flows from the gas supply 42 through regulator 46, control valve 44, tee 36 and lines 38 and 40 to nozzles 32 and 34. The gas blowing agent flows from nozzles 32 and 34 into the chamber 20 of the extruder 10 and mixes therein with the liquid polymer or melt. When mixed with the injected gas, the polymer forms internal closed cells. As with the chemical blowing agent, the physical blowing agent is exposed to the melt and results in closed cell voids that compose in the range of 30% to 70% by volume of the total melt. Specific gravity of the melt is in the range of 0.5 to 1.0. This closed cell structure results in a lower density of the melt as well as a lower density of the extruded material after the melt is extruded through die 26 to produce a lineal product having a profile that corresponds to the shape of the die port in die 26.

Alternatively, chemical blowing agents as herein disclosed in connection with FIGS. 1 and 2 can be used in combination with physical blowing agents as disclosed in connection with FIGS. 3 and 4.

The combination of the polyvinyl chloride/glass melt in the presence of a blowing agent has been found to result in a composite extrusion that is weatherable and that is of appropriate density to use as a substitute for lumber in applications such as outdoor decking. Furthermore, it is believed that due to the use of the glass fibers, the disclosed composition has a high modulus and a low coefficient of thermal expansion. The closed cell extruded composition of glass fibers and polyvinyl chloride has been found to have preferred mechanical properties—namely, greater tensile, flexural, and impact strength. It has also been found to have greater dimensional stability and less mechanical distortion in response to temperature increases.

The plank 146 disclosed herein has been found to provide a stable interface with joists and other support surfaces. The bottom surface 154 defines a continuous concave surface that forms an arch with respect to the portion of the support surfaces between the ends 156 and 158. The ends 156 and 158 of bottom surface 154 cooperated with sides 150 and 152 to form corner junctions or curved shoulders 160 and 162 that contact the support surface. This arrangement has been found to provide a plank that is stable and avoids rolling when walked on. Due to this shape, the disclose plank retains its stability and can tolerate some movement of the joints or other support surfaces.

While several presently preferred embodiments of the invention have been shown and described herein, the presently disclosed invention is not limited thereto but can be otherwise variously embodied within the scope of the following claims.

1. A process of making deck planks, said process comprising the steps of:
blending polyvinyl chloride with glass fibers to make a polyvinyl chloride/glass melt in which the glass fibers are imbedded in the polyvinyl chloride;
Exposing the polyvinyl chloride/glass melt to a blowing agent to form voids in the polyvinyl chloride/glass melt;
extruding the polyvinyl chloride/glass melt having included voids through a die, said extrusion die having an opening therein that is defined by first and second side surfaces that are oppositely disposed from each other and by top and bottom surfaces that are also oppositely disposed from each other and that are substantially orthogonal with respect to said first and second side surfaces;
pulling the extruded material through a calibration table wherein the extruded material is cooled as it passes through a plurality of calibrators that further define the external shape of the extruded material, each of said calibrators having a respective opening that is defined by first and second side walls and by top and bottom walls that are orthogonal with respect to said first and second side walls; and
cutting said extruded material to a predetermined length.

2. The method of claim 1 wherein the bottom wall of at least one of said calibrators define a generally continuous convex surface.

3. The method of claim 2 wherein said bottom wall of at least one calibrator defines an arc of substantially constant radius.

4. The method of claim 3 wherein the radius of the arc of said bottom wall of at least one calibrator is not less than 50 inches.

5. The method of claim 4 wherein said generally continuous convex surface of the bottom wall of at least one of said calibrators has a first end that joins with the respective first side wall of said calibrator and said generally continuous convex surface of the bottom wall also has a second end that joins with the respective second side wall.

6. The method of claim 5 wherein the junction of the first end of said continuous convex wall and said first side wall defines a first curved shoulder and wherein the junction of the second end of said continuous convex wall and said second side wall defines a second curved shoulder.

7. The method of claim 6 wherein said first curved shoulder defines a constant radius and where said second curved shoulder also defines a constant radius.

8. The method of claim 7 wherein the radius of each of said first curved shoulder and said second curved shoulder is not greater than substantially 0.25 in.

9. The method of claim 8 further comprising the step of;
embossing the top surface of said extruded material to provide an embossed pattern in the surface thereof.

10. A process for making deck planks, said process comprising the steps of:
combining polyvinyl chloride, glass fibers, and a blowing agent to form a feed mixture.
providing the feed mixture to an extruder, said extruder increasing the temperature and pressure on the feed mixture to form a polyvinyl chloride/glass melt wherein the concentration of said glass fibers is in the range of 1% to 18% by weight;
extruding the polyvinyl chloride/glass melt having included voids through a die, said extrusion die having an opening therein that is defined by first and second side surfaces that are oppositely disposed from each other and by top and bottom surfaces that are also oppositely disposed from each other and that are substantially orthogonal with respect to said first and second side surfaces;
pulling the extruded material through a calibration table wherein the extruded material is cooled as it passes through a plurality of calibrators that further define the external shape of the extruded material, each of said calibrators having a respective opening that is defined by first and second side walls and by top and bottom walls that are orthogonal with respect to said first and second side walls; wherein the bottom wall of at least one of said calibrators defines a generally continuous convex surface, and
cutting said extruded material to a predetermined length.

11. The process of claim 10 wherein the blowing agent is a chemical blowing agent that is mixed with the polyvinyl chloride and glass fibers prior to formation of the polyvinyl chloride/glass melt, said chemical blowing agent cooperating with the polyvinyl chloride/glass melt to form voids in the polyvinyl chloride/glass melt and in the extruded shape.

12. The process of claim 10 wherein said blowing agent is mixed with a carrier material.

13. The process of claim 12 wherein said carrier material is selected from the group of calcium carbonate, polyvinyl chloride, or ethylene vinyl acetate.

14. The process of claim 10 wherein the chemical blowing agent is azodicarbonamide.

15. The process of claim 10 wherein the blowing agent that is mixed with the polyvinyl chloride/glass melt is carbon dioxide.

16. The process of claim 10 wherein the blowing agent that is mixed with the polyvinyl chloride/glass melt is nitrogen.

17. The process of claim 10 wherein the blowing agent that is mixed with the polyvinyl chloride/glass melt is from the chloroflorocarbon family of gases.

18. The process of claim 10 wherein the blowing agent that is mixed with the polyvinyl chloride/glass melt is from the butane family of gases.
